(19) United States
(12) Patent Application Publication
(10) Pub. No.: US 2025/0351202 A1
(43) Pub. Date: Nov. 13, 2025

(54) TECHNIQUES FOR ENERGY-EFFICIENT INITIAL ACCESS PROCEDURE

(71) Applicant: QUALCOMM Incorporated, San Diego, CA (US)

(72) Inventors: Ahmed BEDEWY, Hillsborough, NJ (US); Naeem AKL, BRIDGEWATER, NJ (US); Navid ABEDINI, Basking Ridge, NJ (US)

(21) Appl. No.: 18/660,054

(22) Filed: May 9, 2024

(51) Int. Cl. H04W 76/10; H04W 60/04; H04W 76/20; H04W 84/04

(52) U.S. Cl. CPC H04W 76/10; H04W 60/04; H04W 76/20; H04W 84/042

(57) ABSTRACT

Methods, systems, and devices for method for wireless communication are described. A user equipment (UE) may transmit, to a network entity, a request for a system information block associated with a cell. In some cases, the request for the system information block may include an indication of an operator identifier associated with the UE. The UE may receive from the network entity, a response to the request for the system information block based on the indication of the operator identifier associated with the UE. In some examples, the network entity may transmit the system information block based on the indication of the operator identifier associated with the UE. In some examples, the network entity may transmit a negative acknowledgement feedback message based on the indication of the operator identifier associated with the UE.

### FIELD OF TECHNOLOGY

The following relates to method for wireless communication, including techniques for energy-efficient initial access procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, to a first network entity, a request for a system information block associated with a cell, where the request for the system information block includes an indication of an operator identifier associated with the UE and receiving, from the first network entity, a response to the request for the system information block based on the indication of the operator identifier associated with the UE.

A UE for wireless communications is described. The UE may include one or more memories storing processor executable code, and one or more processors coupled with the one or more memories. The one or more processors may individually or collectively be operable to execute the code to cause the UE to transmit, to a first network entity, a request for a system information block associated with a cell, where the request for the system information block includes an indication of an operator identifier associated with the UE and receive, from the first network entity, a response to the request for the system information block based on the indication of the operator identifier associated with the UE.

Another UE for wireless communications is described. The UE may include means for transmitting, to a first network entity, a request for a system information block associated with a cell, where the request for the system information block includes an indication of an operator identifier associated with the UE and means for receiving, from the first network entity, a response to the request for the system information block based on the indication of the operator identifier associated with the UE.

A non-transitory computer-readable medium storing code for wireless communications is described. The code may include instructions executable by one or more processors to transmit, to a first network entity, a request for a system information block associated with a cell, where the request for the system information block includes an indication of an operator identifier associated with the UE and receive, from the first network entity, a response to the request for the system information block based on the indication of the operator identifier associated with the UE.

In some examples of the method, UEs, and non-transitory computer-readable medium described herein, receiving the response may include operations, features, means, or instructions for receiving, from the first network entity, the system information block based on the indication of the operator identifier associated with the UE, where the UE and the first network entity may be associated with a common operator.

In some examples of the method, UEs, and non-transitory computer-readable medium described herein, receiving the response may include operations, features, means, or instructions for receiving, from the first network entity, a negative acknowledgement feedback message based on the indication of the operator identifier associated with the UE, where the UE and the first network entity may be associated with different operators.

In some examples of the method, UEs, and non-transitory computer-readable medium described herein, the negative acknowledgement feedback message includes an indication of a reason for denial of the request for the system information block.

In some examples of the method, UEs, and non-transitory computer-readable medium described herein, transmitting the request for the system information block may include operations, features, means, or instructions for transmitting a preamble signal requesting the system information block associated with the cell, where a sequence of the preamble signal indicates the operator identifier associated with the UE.

In some examples of the method, UEs, and non-transitory computer-readable medium described herein, transmitting the request for the system information block may include operations, features, means, or instructions for transmitting a message associated with a random access channel procedure, where the message includes a payload indicating the operator identifier associated with the UE.

In some examples of the method, UEs, and non-transitory computer-readable medium described herein, the operator identifier associated with the UE includes a complete public land mobile network identifier, or a partial public land mobile network identifier.

Some examples of the method, UEs, and non-transitory computer-readable medium described herein may further include operations, features, means, or instructions for receiving a downlink signal including a preamble identifier associated with the operator identifier, where the downlink signal includes at least one of system information associated with the cell or a second cell, a radio resource control signal, a non-access stratum message, a location-specific signal, or any combination thereof.

In some examples of the method, UEs, and non-transitory computer-readable medium described herein, the location-specific signal may be associated with a registration area of the UE or a radio access network based notification area or both.

In some examples of the method, UEs, and non-transitory computer-readable medium described herein, a preamble identifier associated with the operator identifier may be preconfigured or obtained by the UE from a server.

Some examples of the method, UEs, and non-transitory computer-readable medium described herein may further include operations, features, means, or instructions for receiving, from a second network entity, a downlink signal including a preamble identifier indicating the operator identifier associated with the UE.

Some examples of the method, UEs, and non-transitory computer-readable medium described herein may further include operations, features, means, or instructions for receiving, from the first network entity and prior to transmitting the request for the system information block, a broadcast signal associated with the cell, where the broadcast signal includes an indication of an operator identifier.

Some examples of the method, UEs, and non-transitory computer-readable medium described herein may further include operations, features, means, or instructions for comparing the operator identifier associated with the cell with the operator identifier associated with the UE, where transmitting the request for the system information block may be based on the operator identifier associated with the cell and the operator identifier associated with the UE being same.

In some examples of the method, UEs, and non-transitory computer-readable medium described herein, the request for the system information block associated with the cell may be based on obtaining a list of a set of multiple cell identifiers for a set of multiple cells associated with a common operator for a geographical location and the cell may be included in the set of multiple cells.

In some examples of the method, UEs, and non-transitory computer-readable medium described herein, receiving the response may include operations, features, means, or instructions for receiving, from the first network entity, a negative acknowledgement feedback message based on the indication of the operator identifier associated with the UE, where the negative acknowledgement feedback message indicates that the first network entity may be not ready to transmit the system information block, the UE and the first network entity being associated with same operators.

In some examples of the method, UEs, and non-transitory computer-readable medium described herein, the operator identifier includes an index indicating operator information and the index may be included in a hash table.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for energy-efficient initial access procedure in accordance with one or more aspects of the present disclosure.

FIG. 2 shows an example of a network architecture that supports techniques for energy-efficient initial access procedure in accordance with one or more aspects of the present disclosure.

FIG. 3 shows an example of a wireless communications system that supports techniques for energy-efficient initial access procedure in accordance with one or more aspects of the present disclosure.

FIG. 4 shows an example of a process flow that supports techniques for energy-efficient initial access procedure in accordance with one or more aspects of the present disclosure.

FIGS. 5 and 6 show block diagrams of devices that support techniques for energy-efficient initial access procedure in accordance with one or more aspects of the present disclosure.

FIG. 7 shows a block diagram of a communications manager that supports techniques for energy-efficient initial access procedure in accordance with one or more aspects of the present disclosure.

FIG. 8 shows a diagram of a system including a device that supports techniques for energy-efficient initial access procedure in accordance with one or more aspects of the present disclosure.

FIGS. 9 through 13 show flowcharts illustrating methods that support techniques for energy-efficient initial access procedure in accordance with one or more aspects of the present disclosure.

### DETAILED DESCRIPTION

In wireless communications systems, a network entity may periodically broadcast a system information block or remaining minimum system information for user equipments (UEs) to use in establishing a connection with the network entity. The system information block (SIB) may be, for example, a system information block 1 (SIB1) message, which may indicate basic information for a UE to perform an initial access procedure. However, periodic broadcast of such information may increase the power usage at the network entity. In some cases, a network entity may operate using a network energy savings technique, in which a network entity may suppress periodically broadcasting a system information block or remaining minimum system information. In such cases, an anchor cell may provide a copy of the SIB1 or the cell may transmit SIB1 in response to a request (e.g., from a UE). In some cases, the UE and the network entity may belong to different operators. Without the knowledge of operators, the UE may request a system information block (during initial access) from a network entity associated with a different operator than the UE. In such a case, the network entity may waste energy sending a system information block as a response to a UE that belongs to a different operator. Additionally, the UE may waste power and time processing a system information block from network entities that do not belong to the same operator.

Techniques depicted herein provide for indication of an operator identifier by a UE. In some examples, a UE may transmit the indication of the operator identifier during initial access of a cell. For example, a UE may transmit a request for a system information block associated with the cell, and the UE may include an indication of an operator identifier associated with the UE in the request for the system information block. Upon receiving the request for the system information block from the UE, the network entity may determine that the UE belongs to the same operator. In this case, the network entity may respond with the system information block. Alternatively, upon receiving the request for the system information block from the UE, the network entity may determine that the UE belongs to a different operator. In this case, the network entity may either send a negative acknowledgement signal to the UE or may refrain from sending a response. Upon receiving a response from the network entity (or upon not receiving anything for a threshold period of time), the UE may initiate a search for another cell.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to techniques for energy-efficient initial access procedure.

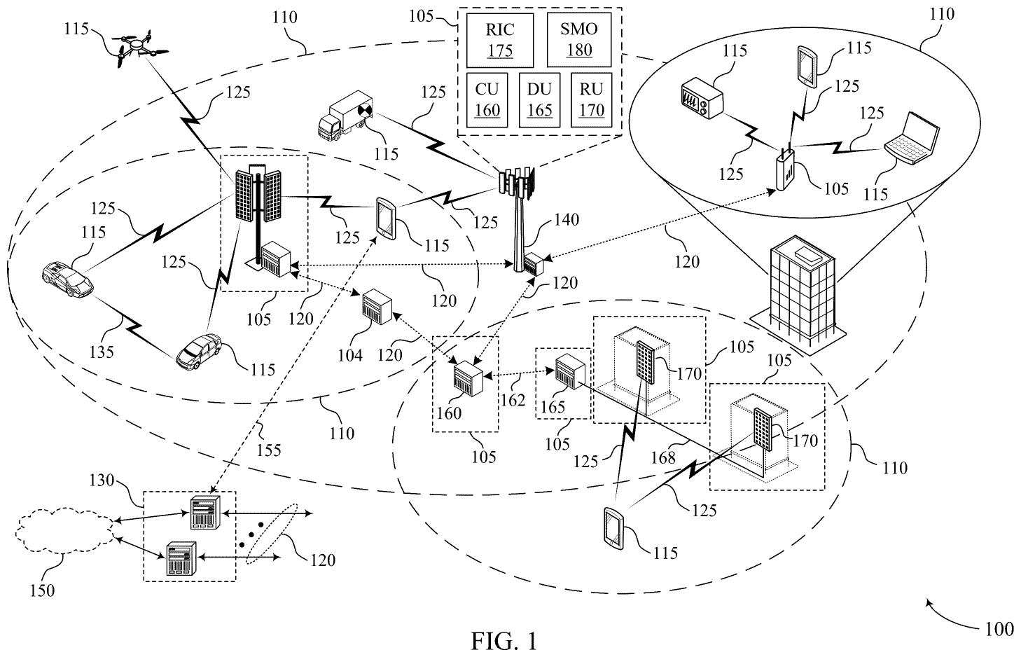

FIG. 1 shows an example of a wireless communications system 100 that supports techniques for energy-efficient initial access procedure in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a network energy savings may involve a cell not periodically broadcasting a system information block or remaining minimum system information or both. In some examples, when a network entity is operating in such network energy savings mode, an anchor cell may provide a copy of a network energy savings cell's system information block. In some examples, without the presence of an anchor cell, the network entity (e.g., network energy savings cell) may transmit the system information block in response to a request (e.g., from a UE). It may be advantageous to support such a feature in a standalone manner, with no (or minimal) reliance on an anchor/assisting cell. (e.g., to support direct access to a cell without any information from a second cell). To achieve that, a UE may operate using a configuration of an uplink demand signal (also referred to an uplink wakeup signal) that an idle/inactive UE may send to a cell requesting a system information block.

In some cases, for an assisted access, the anchor cell may provide this information. For non-assisted access, this information may be included in a master information block. In some examples, the resources/configurations to send the uplink wakeup signal during an assisted access may be provided by the system information sent by a neighboring or anchor cell. Alternatively, for non-assisted access, the master information block may include one or more fields indicating a remaining minimum system information physical downlink control channel configuration. In an example where there is no triggered remaining minimum system information transmission, these bits can be repurposed to indicate the uplink wakeup signal configuration. In some examples, in cycles where remaining minimum system information is transmitted (e.g., triggered), a master information block may indicate a remaining minimum system information configuration. In other cycles, it may indicate an uplink wakeup signal configuration. Additionally, or alternatively, a flag (in the master information block and/or other signals like a primary synchronization signal, a secondary synchronization signal, a demodulation reference signal, or via an implicit index modulation) may indicate to the UE how to interpret the content of a master information block. However, in the absence of a system information block broadcast, the UE 115 may be unable to identify a cell operator identifier.

Techniques depicted herein provide for energy-efficient initial access procedure. In some examples, a UE 115 may transmit, to a network entity 105, a request for a system information block associated with a cell. In some cases, the request for the system information block may include an indication of an operator identifier associated with the UE 115. The UE 115 may receive from the network entity 105, a response to the request for the system information block based on the indication of the operator identifier associated with the UE 115. In some examples, the network entity 105 may transmit the system information block based on the indication of the operator identifier associated with the UE 115. In some examples, the network entity 105 may transmit a negative acknowledgement feedback message based on the indication of the operator identifier associated with the UE 115.

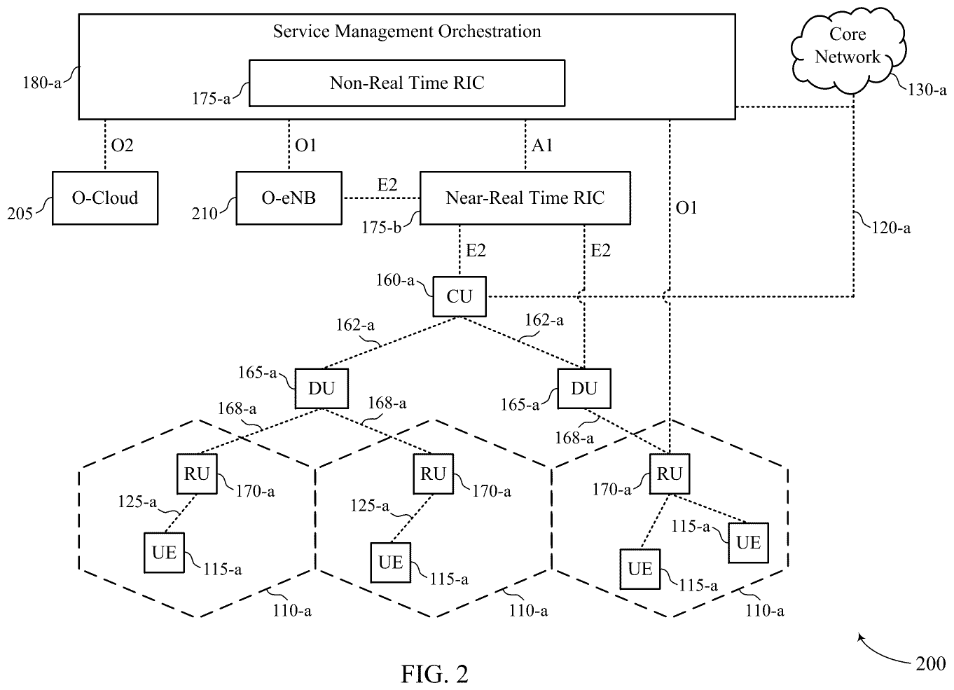

FIG. 2 shows an example of a network architecture 200 (e.g., a disaggregated base station architecture, a disaggregated RAN architecture) that supports techniques for energy-efficient initial access procedure in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples, a UE 115 may transmit, to a network entity 105, a request for a system information block associated with a cell. In some cases, the request for the system information block may include an indication of an operator identifier associated with the UE 115. The UE 115 may receive from the network entity 105, a response to the request for the system information block based on the indication of the operator identifier associated with the UE 115.

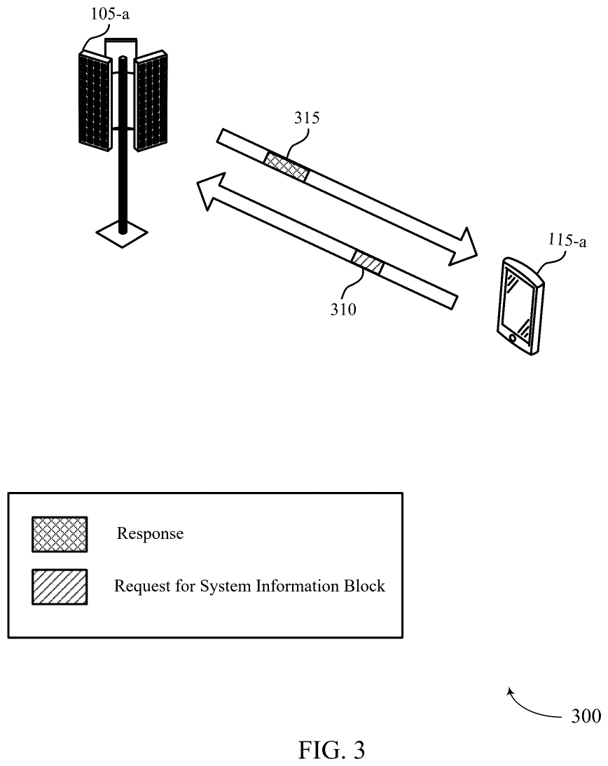

FIG. 3 shows an example of a wireless communications system 300 that supports techniques for energy-efficient initial access procedure in accordance with one or more aspects of the present disclosure. The wireless communications system 300 includes communications between a UE 115-a and a network entity 105-a. The wireless communications system 300 may be an example of a wireless communications system 100 as described with reference to FIG. 1. The UE 115-a may be an example of a UE 115 as described with reference to FIG. 1. The wireless communications system 300 may additionally include one or more network entities 105, which may be examples of CUs, DUs, RUs, or any combination thereof, as described with reference to FIGS. 1 and 2. As depicted herein, the wireless communications system 300 may support an energy-efficient initial access procedure.

In some wireless communications systems, a UE 115 may communicate with a network entity in accordance with a cell operator identifier. The UE 115 may identify the cell operator identifier from a system information block broadcast. In some cases, the system information block (e.g., SIB1) may be periodically broadcast by a network entity 105 regardless of requests or presence of UEs 115 (continuously periodically broadcast). As a result, the UE 115 may be able to identify the cell operator identifier without requesting it from the network entity 105. However, in some cases, the network entity 105 may suppress continuously broadcasting the system information block. For instance, the network entity 105 may transmit the system information block transmission on-demand. However, in such cases, the network entity 105 may waste energy sending system information blocks in response to requests from UEs that belong to different operators. Additionally, or alternatively, the UE 115 may waste power and time processing system information blocks of cells that do not belong to the same operator. These issues may be more prevalent in cases where the UE 115 has not received the system information block, because the association between cell and operator identifier may be known to the UE 115 post the acquisition of the system information block.

According to one or more aspects of the present disclosure, the UE 115-a and the network entity 105-a may operate to perform energy-efficient initial access procedure. In some examples, the UE 115-a may transmit, to the network entity 105-a, a request 310 for a system information block associated with a cell. In some examples, the request for the system information block may include an indication of an operator identifier associated with the UE 115-a. As depicted herein, during the initial access by the UE 115-a, the UE 115-a may send a request for a system information block, where the request indicates the operator identifier that the UE belongs to. The network entity 105-a, upon receiving the request, may transmit a response 315 to the request for the system information block based on the indication of the operator identifier associated with the UE 115-a. For example, the network entity 105-a may determine that the UE 115-a and the network entity 105-a belong to the same operator. In this case, the network entity 105-a may respond with the system information block. For instance, the UE 115-a may receive the system information block based on the indication of the operator identifier associated with the UE 115-a. In this case, the UE 115-a and the network entity 105-a may be associated with a common operator.

Alternatively, the network entity 105-a may determine that the UE 115-a belongs to a different operator. In this case, the network entity 105-a may transmit a negative acknowledgement signal to the UE 115-a. For example, the UE 115-a may receive a negative acknowledgement feedback message based on the indication of the operator identifier associated with the UE 115-a. In this case, the UE 115-a and the network entity 105-a may be associated with different operators. Upon receiving the negative acknowledgement signal, the UE 115-a may initiate a search for another cell. For example, the UE 115-a may retransmit the request for the system information block to a second network entity 105 (not shown) upon receiving the negative acknowledgement signal. In some examples, the network entity 105-a may ignore the request from the UE 115-a (not respond to the request 310). In such cases, the UE 115-a may wait for a response for a threshold time period. If the UE 115-a does not receive a response within the threshold time period, then the UE 115-a may reinitiate the search for another cell.

In some examples, the UE 115-a may transmit a preamble signal requesting the system information block associated with the cell, where a sequence of the preamble signal indicates the operator identifier associated with the UE 115-a. As discussed herein, the signal that the UE 115-a sends to request the system information block may be a preamble signal, where the operator identifier may be indicated by a preamble identifier dedicated for requesting a system information block from a cell of corresponding operator (e.g., the preamble that is sent by the UE 115-a).

In some examples, the UE 115-a may transmit a message associated with a random access channel procedure, where the message includes a payload indicating the operator identifier associated with the UE 115-a. For instance, the UE 115-a may transmit a Msg A or a Msg 3. In some examples, the Msg A payload may include a complete public land mobile network identifier, or a partial public land mobile network identifier. In some cases, the Msg 3 may include a complete public land mobile network identifier, or a partial public land mobile network identifier. In some examples, the UE 115-a may include further information in Msg 3. This way, the network entity 105-a may save energy by not sending a system information block to UEs that do not belong to the same operator. Additionally, or alternatively, using the techniques described herein, the UE 115-a may save power and time by not decoding system information blocks from cells that do not belong to the same operator.

In some examples, the UE 115-a may receive a downlink signal including a preamble identifier associated with the operator identifier. In some cases, the downlink signal may include at least one of system information associated with the cell or a second cell, an RRC signal, a non-access stratum message, a location-specific signal, or any combination thereof. For instance, the UE 115-a may utilize the preamble identifier to identify the operator identifier. In some cases, the preamble identifier associated with the operator identifier may be preconfigured or obtained by the UE 115-a from a server. For example, the UE 115-a may obtain the preamble identifier from data stored in a server (e.g., cloud server). The server may gather this information (related to preamble identifiers) based on updates sent by other UEs and/or network entities. In some cases, the UE 115-a may acquire the preamble identifier from the network entity 105-a (e.g., RAN) or from system information (a system information block or other system information) of the same or other cell on which UE 115-a camped on previously. Additionally, or alternatively, the UE 115-a may receive the preamble identifier from an RRC release message or an RRC reconfiguration message prior to releasing the UE's connection. In some examples, the UE 115-a may receive the preamble identifier in a non-access stratum message from the core network. In some cases, the indication of preamble identifier (e.g., via RRC or non-access stratum message) may be location specific (e.g., specific to UE registration area or RAN-based Notification Area).

In some cases, the UE 115-a may receive the preamble identifier from a network entity and the UE 115-a may send the preamble identifier to a cell served by a second network entity. To efficiently communicate in such a scenario, the two network entities operate in a synchronized manner (e.g., the UE 115-a and one or more network entities may be coordinated over F1, Xn-C and/or NG interfaces). For example, the UE 115-a may receive the preamble identifier via a system information block that is sent from a first DU. Then, the UE 115-a may move to a second DU within the same network entity. The second DU may not identify the preamble identifier that the UE 115-a had received from the first DU. To efficiently communicate, DUs (e.g., the first DU and the second DU) within the same network entity may be coordinated. Such a coordination may be achieved through a CU using the F1 interface. In some examples, the UE 115 may receive the preamble identifier via a system information block that is sent from a DU in a first network entity. Then, the UE 115-a may move to a second network entity. The DUs in the second network entity may not identify the preamble identifier that the UE 115-a had received from the DU in the first network entity. To efficiently communicate, the network entities (e.g., the first network entity and the second network entity) may be coordinated. Such coordination may be achieved using Xn-C interface.

In some examples, the UE 115 may receive the preamble identifier via a system information block that is sent from a CU in a first network entity. Then, the UE 115-a may move to a second network entity. The CU in the second network entity may not be able to identify the preamble identifier that the UE 115-a had received from the CU in the first network entity. To efficiently communicate, the network entities (e.g., the first network entity and the second network entity) may be coordinated. Such coordination may be achieved using Xn-C interface. Additionally, or alternatively, the UE 115 may receive the preamble identifier via an RRC message that is sent from a CU in a first network entity. Then, the UE 115-a may move to a second network entity. The CU in the second network entity may not be able to identify the preamble identifier that the UE 115-a had received from the CU in the first network entity. To efficiently communicate, the network entities (e.g., the first network entity and the second network entity) may be coordinated. Such coordination may be achieved using Xn-C interface.

In some examples, the UE 115 may receive the preamble identifier via a non-access stratum message that is sent from a core network through a first network entity. Then, the UE 115-a may move to a second network entity. The second network entity may not be able to identify the preamble identifier that the UE 115-a had received from the core network while the UE 115-a was under the coverage of the first network entity. To efficiently communicate, the network entities (e.g., the first network entity and the second network entity) may be coordinated. Such a coordination may be achieved through the core network using an NG interface. It is to be understood that such coordination may be a notification, a request, or both.

In some examples, if the network entity 105-a is serving multiple operators and the UE 115-a belongs to one of them, then, upon receiving the request 310, the network entity 105-a may respond back with a system information block that carries the information for this particular operator (a light system information block signal), thereby saving more energy. This technique may be applicable to both anchor and non-anchor scenarios. For example, the network entity 105-a may be associated with a set of multiple operators including an operator associated with the operator identifier, and the system information block may include information associated with the operator.

In some cases of on-demand synchronization signal block requests, the UE 115-a may transmit a request for a refined synchronization signal block. When the UE 115-a transmits a request for a refined synchronization signal block, the request may indicate the operator identifier of the UE 115-a. If the network entity 105-a determines that the UE 115-a does not belong to the same operator, the network entity 105-a may transmit a negative acknowledgement signal to the UE 115-a. In some cases, if the network entity 105-a determines that the UE 115-a does not belong to the same operator, then the network entity 105-a may ignore the request from the UE 115-a, and refrain from transmitting a response. Using the techniques depicted herein, the network entity 105-a may save energy by not sending refined synchronization signal blocks (or repeated synchronization signal blocks) to UEs that belong to different operators. Additionally, or alternatively, the UE 115-a may save power and time in decoding the demanded synchronization signal blocks from cells that belong to different operators.

In some examples, the negative acknowledgement feedback message may include an indication of a reason for denial of the request for the system information block. For example, the negative acknowledgement signal sent from the network entity 105-a may encode some information about the refusal reason (e.g., not same operator, cell not ready to send system information block, network entity operating in an energy saving mode, etc.). For instance, after transmitting the request 310, the UE 115-a may receive, from the network entity 105-a, a negative acknowledgement feedback message based on the indication of the operator identifier associated with the UE 115-a, where the negative acknowledgement feedback message may indicate that the network entity 105-a is not ready to transmit the system information block. In such cases, the UE 115-a and the network entity 105-a may be associated with same operators.

After receiving the negative acknowledgement feedback message, the UE 115-a may check for the reason of denial. If the reason of denial states that the UE 115-a and the network entity 105-a belong to different operators, then the UE 115-a may search for another cell and omit the current cell (associated with the network entity 105-a) for future re-connections. In some examples, if the reason of denial states that the UE 115-a and the network entity 105-a belong to the same operator, but the network entity is not ready to broadcast system information block, then the UE 115-a may continue to search for another cell but may not ignore the current cell for future re-connections.

In some examples, instead of conveying the whole operator identifier, the UE 115-a may use a hash table to convey an index indicating its operator identifier. For example, the operator identifier may include an index indicating operator information, and the index may be included in a hash table. In some examples, the hash table may be preconfigured or included in a server. Additionally, or alternatively, the UE 115-a may receive the hash table via at least one of system information associated with the cell or a second cell, an RRC signal, a non-access stratum message, a location-specific signal, or any combination thereof.

In some examples, the UE 115-a may receive, from the network entity 105-a and prior to transmitting the request for the system information block, a broadcast signal associated with the cell. In such cases, the broadcast signal may include an indication of the operator identifier. For example, a modification to a master information block may indicate the public land mobile network identifier of a cell. In some examples, the public land mobile network identifier may be encoded in the master information block. Additionally, or alternatively, the master information block may include an index for a hash table associated with the public land mobile network identifier. In some cases, the hash table may be preconfigured or included in a server. Additionally, or alternatively, the UE 115-a may receive the hash table via at least one of system information associated with the cell or a second cell, an RRC signal, a non-access stratum message, a location-specific signal, or any combination thereof. Upon receiving the master information block (or any other broadcast signal received prior to transmitting the request 310), the UE 115-a may decode the received signal to identify the cell operator information. In such cases, the UE 115-a may make an early decision of cell suitability. This may result in energy savings for network entities and UEs, and may also increase the speed of an initial access procedure for the UE.

In some examples, the request 310 for the system information block associated with the cell may be based on obtaining a list of a set of cell identifiers for a set of cells associated with a common operator for a geographical location. The cell may be included in the set of cells. For example, the UE 115-a may maintain a set of cell identifiers (or frequencies) belonging to its operator in a given location. This may enable the UE 115-a to make an early decision regarding the cell suitability. In some examples, the list of the set of cell identifiers may be preconfigured or included in a server. Additionally, or alternatively, the UE 115-a may receive the list of the set of cell identifiers via at least one of system information associated with the cell or a second cell, an RRC signal, a non-access stratum message, a location-specific signal, or any combination thereof.

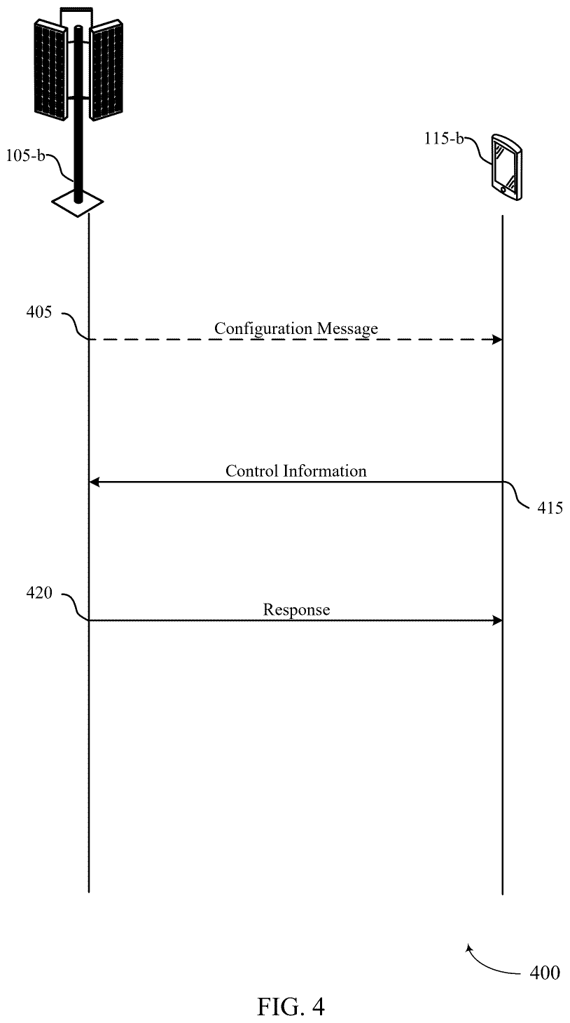

FIG. 4 shows an example of a process flow 400 that supports techniques for energy-efficient initial access procedure in accordance with one or more aspects of the present disclosure. The process flow 400 includes a UE 115-b and a network entity 105-b, which may be examples of the corresponding devices as described with respect to FIGS. 1, 2 and 3. In the following description of the process flow 400, the operations between the UE 115-b and the network entity 105-b may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-b may optionally receive, from the network entity 105-b, a broadcast signal associated with a cell. In some examples, the broadcast signal may include an indication of an operator identifier associated with the cell.

At 415, the UE 115-b may transmit, to the network entity 105-b, a request for a system information block associated with the cell. In some examples, the request for the system information block may include an indication of the operator identifier associated with the UE 115-b.

In some cases, the UE 115-b may transmit a preamble signal requesting the system information block associated with the cell, where a sequence of the preamble signal indicates the operator identifier associated with the UE 115-b. Additionally, or alternatively, the UE 115-b may transmit a message associated with a random access channel procedure, where the message includes a payload indicating the operator identifier associated with the UE 115-b. In some cases, the operator identifier associated with the UE 115-b may include a complete public land mobile network identifier or a partial public land mobile network identifier.

At 420, the UE 115-b may receive, from the network entity 105-b, a response to the request for the system information block based on the indication of the operator identifier associated with the UE 115-b. In some examples, the UE 115-b may receive the system information block based on the indication of the operator identifier associated with the UE 115-b, where the UE 115-b and the network entity 105-b are associated with a common operator. Alternatively, the UE 115-b may receive a negative acknowledgement feedback message based on the indication of the operator identifier associated with the UE 115-b, where the UE 115-b and the network entity 105-b are associated with different operators. In some examples, the negative acknowledgement feedback message may include an indication of a reason for denial of the request for the system information block.

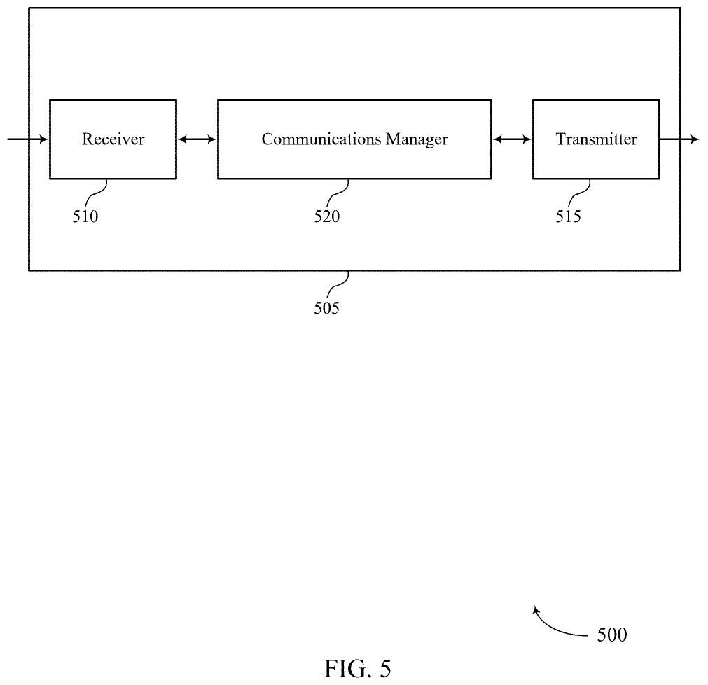

FIG. 5 shows a block diagram 500 of a device 505 that supports techniques for energy-efficient initial access procedure in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for energy-efficient initial access procedure). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for energy-efficient initial access procedure). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for energy-efficient initial access procedure as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting, to a first network entity, a request for a system information block associated with a cell, where the request for the system information block includes an indication of an operator identifier associated with the UE. The communications manager 520 is capable of, configured to, or operable to support a means for receiving, from the first network entity, a response to the request for the system information block based on the indication of the operator identifier associated with the UE.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

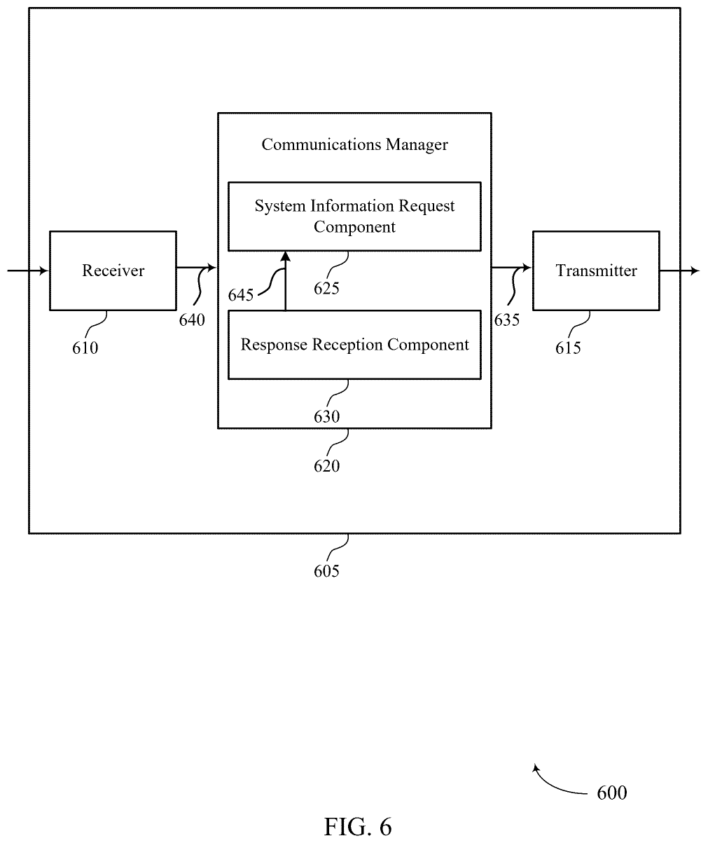

FIG. 6 shows a block diagram 600 of a device 605 that supports techniques for energy-efficient initial access procedure in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for energy-efficient initial access procedure). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for energy-efficient initial access procedure). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for energy-efficient initial access procedure as described herein. For example, the communications manager 620 may include a system information request component 625 a response reception component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The system information request component 625 is capable of, configured to, or operable to support a means for transmitting, to a first network entity, a request for a system information block associated with a cell, where the request for the system information block includes an indication of an operator identifier associated with the UE. For example, the system information request component 625 may transmit the request 635 to the transmitter 615, which in turn transmits the request to the network entity. The response reception component 630 is capable of, configured to, or operable to support a means for receiving, from the first network entity, a response to the request for the system information block based on the indication of the operator identifier associated with the UE. In some examples, the response reception component 630 may receive a response 640 via the receiver 610 from a network entity. In some examples, the response reception component 630 may forward information 645 related to the response to the system information request component 625.

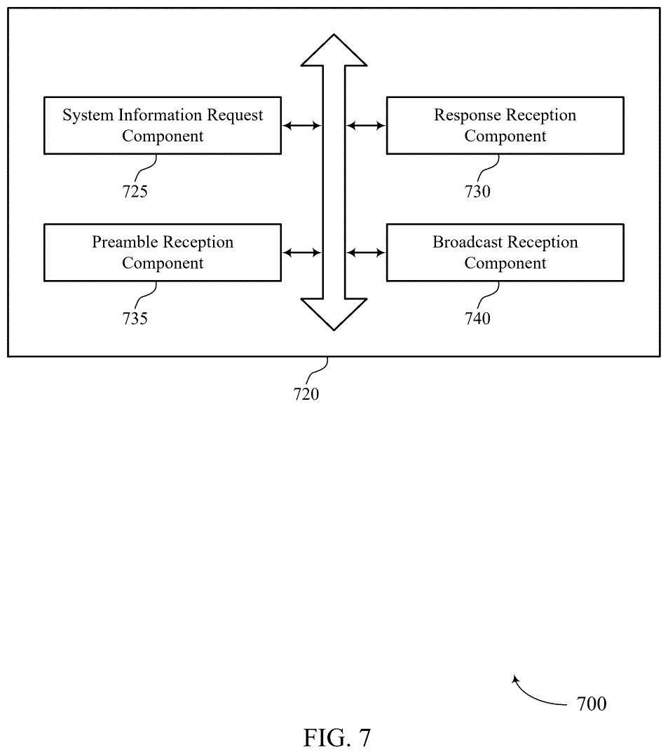

FIG. 7 shows a block diagram 700 of a communications manager 720 that supports techniques for energy-efficient initial access procedure in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for energy-efficient initial access procedure as described herein. For example, the communications manager 720 may include a system information request component 725, a response reception component 730, a preamble reception component 735, a broadcast reception component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The system information request component 725 is capable of, configured to, or operable to support a means for transmitting, to a first network entity, a request for a system information block associated with a cell, where the request for the system information block includes an indication of an operator identifier associated with the UE. The response reception component 730 is capable of, configured to, or operable to support a means for receiving, from the first network entity, a response to the request for the system information block based on the indication of the operator identifier associated with the UE.

In some examples, to support receiving the response, the response reception component 730 is capable of, configured to, or operable to support a means for receiving, from the first network entity, the system information block based on the indication of the operator identifier associated with the UE, where the UE and the first network entity are associated with a common operator.

In some examples, to support receiving the response, the response reception component 730 is capable of, configured to, or operable to support a means for receiving, from the first network entity, a negative acknowledgement feedback message based on the indication of the operator identifier associated with the UE, where the UE and the first network entity are associated with different operators. In some examples, the negative acknowledgement feedback message includes an indication of a reason for denial of the request for the system information block.

In some examples, to support transmitting the request for the system information block, the system information request component 725 is capable of, configured to, or operable to support a means for transmitting a preamble signal requesting the system information block associated with the cell, where a sequence of the preamble signal indicates the operator identifier associated with the UE.

In some examples, to support transmitting the request for the system information block, the system information request component 725 is capable of, configured to, or operable to support a means for transmitting a message associated with a random access channel procedure, where the message includes a payload indicating the operator identifier associated with the UE. In some examples, the operator identifier associated with the UE includes a complete public land mobile network identifier, or a partial public land mobile network identifier.

In some examples, the preamble reception component 735 is capable of, configured to, or operable to support a means for receiving a downlink signal including a preamble identifier associated with the operator identifier, where the downlink signal includes at least one of system information associated with the cell or a second cell, an RRC signal, a non-access stratum message, a location-specific signal, or any combination thereof.

In some examples, the location-specific signal is associated with a registration area of the UE or a radio access network based notification area or both. In some examples, a preamble identifier associated with the operator identifier is preconfigured or obtained by the UE from a server. In some examples, the preamble reception component 735 is capable of, configured to, or operable to support a means for receiving, from a second network entity, a downlink signal including a preamble identifier indicating the operator identifier associated with the UE.

In some examples, the first network entity is associated with a set of multiple operators including an operator associated with the operator identifier, and the system information block includes information associated with the operator.

In some examples, the broadcast reception component 740 is capable of, configured to, or operable to support a means for receiving, from the first network entity and prior to transmitting the request for the system information block, a broadcast signal associated with the cell, where the broadcast signal includes an indication of an operator identifier associated with the cell.

In some examples, the broadcast reception component 740 is capable of, configured to, or operable to support a means for comparing the operator identifier associated with the cell with the operator identifier associated with the UE. In some cases, transmitting the request for the system information block may be based on the operator identifier associated with the cell and the operator identifier associated with the UE being same.

In some examples, the request for the system information block associated with the cell is based on obtaining a list of a set of multiple cell identifiers for a set of multiple cells associated with a common operator for a geographical location. In some examples, the cell is included in the set of multiple cells.

In some examples, to support receiving the response, the response reception component 730 is capable of, configured to, or operable to support a means for receiving, from the first network entity, a negative acknowledgement feedback message based on the indication of the operator identifier associated with the UE, where the negative acknowledgement feedback message indicates that the first network entity is not ready to transmit the system information block, the UE and the first network entity being associated with same operators. In some examples, the operator identifier includes an index indicating operator information. In some examples, the index is included in a hash table.

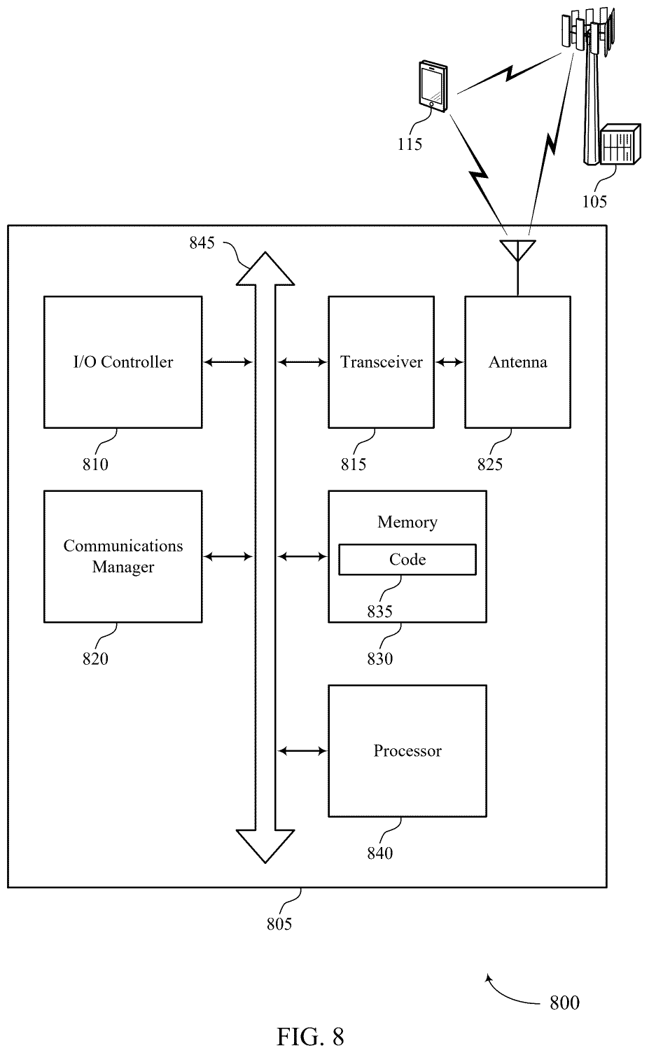

FIG. 8 shows a diagram of a system 800 including a device 805 that supports techniques for energy-efficient initial access procedure in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for energy-efficient initial access procedure). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting, to a first network entity, a request for a system information block associated with a cell, where the request for the system information block includes an indication of an operator identifier associated with the UE. The communications manager 820 is capable of, configured to, or operable to support a means for receiving, from the first network entity, a response to the request for the system information block based on the indication of the operator identifier associated with the UE.

By including or configuring the communications manager 820 in accordance with examples as described herein, the device 805 may support techniques for improved communication reliability, reduced latency, improved user experience related to reduced processing, reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for energy-efficient initial access procedure as described herein, or the at least one processor 840 and the at least one memory 830 may be otherwise configured to, individually or collectively, perform or support such operations.

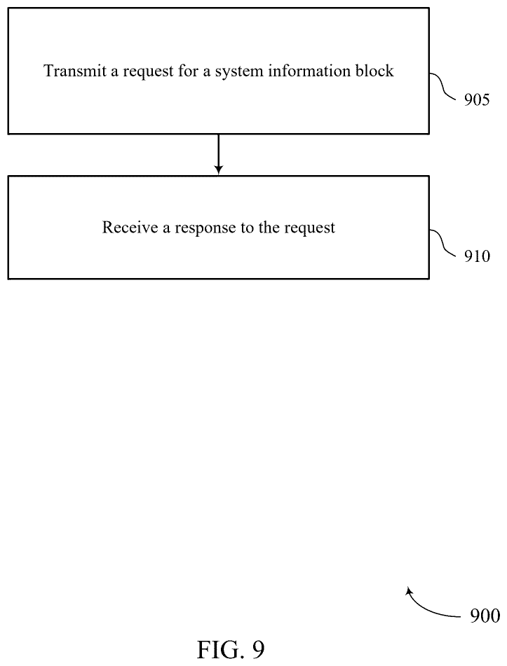

FIG. 9 shows a flowchart illustrating a method 900 that supports techniques for energy-efficient initial access procedure in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting a request for a system information block. The system information block may be associated with a cell. In some cases, the request for the system information block may include an indication of an operator identifier associated with the UE. The operations of 905 may be performed in accordance with examples as disclosed herein. In some examples, aspects of the operations of 905 may be performed by a system information request component 725 as described with reference to FIG. 7.

At 910, the method may include receiving a response to the request. In some examples, the response may be based on the indication of the operator identifier associated with the UE. In some examples, the response includes the requested system information block. In some examples, the response includes a negative acknowledgement feedback message. The operations of 910 may be performed in accordance with examples as disclosed herein. In some examples, aspects of the operations of 910 may be performed.

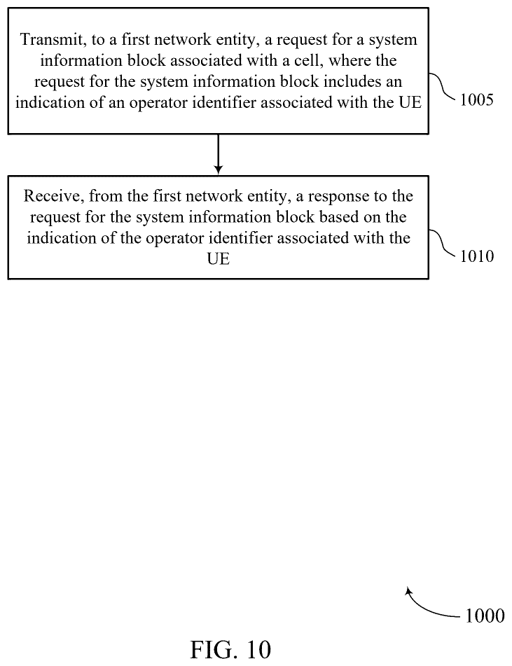

FIG. 10 shows a flowchart illustrating a method 1000 that supports techniques for energy-efficient initial access procedure in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting, to a first network entity, a request for a system information block associated with a cell, where the request for the system information block includes an indication of an operator identifier associated with the UE. The operations of 1005 may be performed in accordance with examples as disclosed herein. In some examples, aspects of the operations of 1005 may be performed by a system information request component 725 as described with reference to FIG. 7.

At 1010, the method may include receiving, from the first network entity, a response to the request for the system information block based on the indication of the operator identifier associated with the UE. The operations of 1010 may be performed in accordance with examples as disclosed herein. In some examples, aspects of the operations of 1010 may be performed by a response reception component 730 as described with reference to FIG. 7.

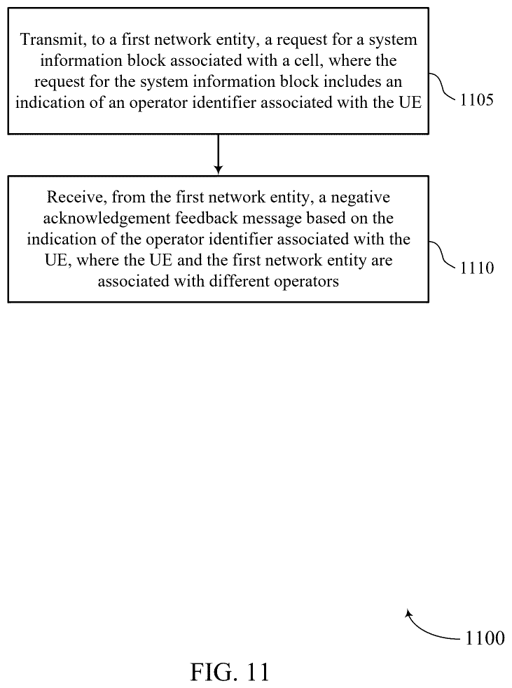

FIG. 11 shows a flowchart illustrating a method 1100 that supports techniques for energy-efficient initial access procedure in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include transmitting, to a first network entity, a request for a system information block associated with a cell, where the request for the system information block includes an indication of an operator identifier associated with the UE. The operations of 1105 may be performed in accordance with examples as disclosed herein. In some examples, aspects of the operations of 1105 may be performed by a system information request component 725 as described with reference to FIG. 7.

At 1110, the method may include receiving, from the first network entity, a negative acknowledgement feedback message based on the indication of the operator identifier associated with the UE, where the UE and the first network entity are associated with different operators. The operations of 1110 may be performed in accordance with examples as disclosed herein. In some examples, aspects of the operations of 1110 may be performed by a response reception component 730 as described with reference to FIG. 7.

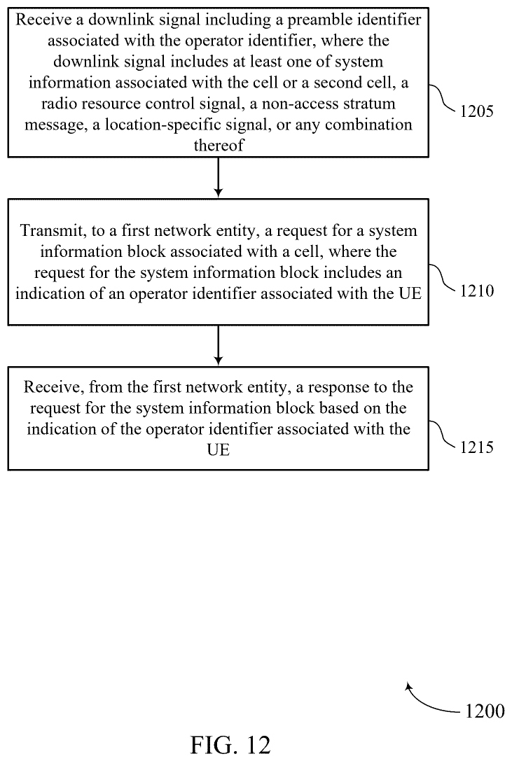

FIG. 12 shows a flowchart illustrating a method 1200 that supports techniques for energy-efficient initial access procedure in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include receiving a downlink signal including a preamble identifier associated with the operator identifier, where the downlink signal includes at least one of system information associated with the cell or a second cell, an RRC signal, a non-access stratum message, a location-specific signal, or any combination thereof. The operations of 1205 may be performed in accordance with examples as disclosed herein. In some examples, aspects of the operations of 1205 may be performed by a preamble reception component 735 as described with reference to FIG. 7.

At 1210, the method may include transmitting, to a first network entity, a request for a system information block associated with a cell, where the request for the system information block includes an indication of an operator identifier associated with the UE. The operations of 1210 may be performed in accordance with examples as disclosed herein. In some examples, aspects of the operations of 1210 may be performed by a system information request component 725 as described with reference to FIG. 7.

At 1215, the method may include receiving, from the first network entity, a response to the request for the system information block based on the indication of the operator identifier associated with the UE. The operations of 1215 may be performed in accordance with examples as disclosed herein. In some examples, aspects of the operations of 1215 may be performed by a response reception component 730 as described with reference to FIG. 7.

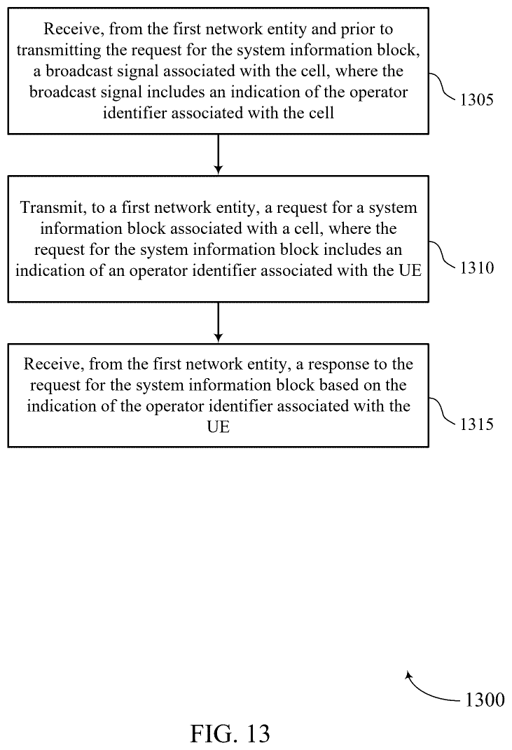

FIG. 13 shows a flowchart illustrating a method 1300 that supports techniques for energy-efficient initial access procedure in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from the first network entity and prior to transmitting the request for the system information block, a broadcast signal associated with the cell, where the broadcast signal includes an indication of an operator identifier associated with the cell. The operations of 1305 may be performed in accordance with examples as disclosed herein. In some examples, aspects of the operations of 1305 may be performed by a broadcast reception component 740 as described with reference to FIG. 7.

At 1310, the method may include transmitting, to a first network entity, a request for a system information block associated with a cell, where the request for the system information block includes an indication of an operator identifier associated with the UE. The operations of 1310 may be performed in accordance with examples as disclosed herein. In some examples, aspects of the operations of 1310 may be performed by a system information request component 725 as described with reference to FIG. 7.

At 1315, the method may include receiving, from the first network entity, a response to the request for the system information block based on the indication of the operator identifier associated with the UE. The operations of 1315 may be performed in accordance with examples as disclosed herein. In some examples, aspects of the operations of 1315 may be performed by a response reception component 730 as described with reference to FIG. 7.

The following provides an overview of aspects of the present disclosure:

Aspect 1: A method for wireless communications at a UE, comprising: transmitting, to a first network entity, a request for a system information block associated with a cell, wherein the request for the system information block comprises an indication of an operator identifier associated with the UE; and receiving, from the first network entity, a response to the request for the system information block based at least in part on the indication of the operator identifier associated with the UE.

Aspect 2: The method of aspect 1, wherein receiving the response further comprises: receiving, from the first network entity, the system information block based at least in part on the indication of the operator identifier associated with the UE, wherein the UE and the first network entity are associated with a common operator.

Aspect 3: The method of any of aspects 1 through 2, wherein receiving the response further comprises: receiving, from the first network entity, a negative acknowledgement feedback message based at least in part on the indication of the operator identifier associated with the UE, wherein the UE and the first network entity are associated with different operators.

Aspect 4: The method of aspect 3, wherein the negative acknowledgement feedback message comprises an indication of a reason for denial of the request for the system information block.

Aspect 5: The method of any of aspects 1 through 4, wherein transmitting the request for the system information block further comprises: transmitting a preamble signal requesting the system information block associated with the cell, wherein a sequence of the preamble signal indicates the operator identifier associated with the UE.

Aspect 6: The method of any of aspects 1 through 5, wherein transmitting the request for the system information block further comprises: transmitting a message associated with a random access channel procedure, wherein the message comprises a payload indicating the operator identifier associated with the UE.

Aspect 7: The method of aspect 6, wherein the operator identifier associated with the UE comprises a complete public land mobile network identifier, or a partial public land mobile network identifier.

Aspect 8: The method of any of aspects 1 through 7, further comprising: receiving a downlink signal comprising a preamble identifier associated with the operator identifier, wherein the downlink signal comprises at least one of system information associated with the cell or a second cell, a radio resource control signal, a non-access stratum message, a location-specific signal, or any combination thereof.

Aspect 9: The method of aspect 8, wherein the location-specific signal is associated with a registration area of the UE or a radio access network based notification area or both.

Aspect 10: The method of any of aspects 1 through 9, wherein a preamble identifier associated with the operator identifier is preconfigured or obtained by the UE from a server.

Aspect 11: The method of any of aspects 1 through 10, further comprising: receiving, from a second network entity, a downlink signal comprising a preamble identifier indicating the operator identifier associated with the UE.

Aspect 12: The method of any of aspects 1 through 11, further comprising: receiving, from the first network entity and prior to transmitting the request for the system information block, a broadcast signal associated with the cell, wherein the broadcast signal comprises an indication of an operator identifier.

Aspect 13: The method of any of aspects 1 through 11, further comprising: comparing the operator identifier associated with the cell with the operator identifier associated with the UE, wherein transmitting the request for the system information block is based at least in part on the operator identifier associated with the cell and the operator identifier associated with the UE being same.

Aspect 14: The method of any of aspects 1 through 12, wherein the request for the system information block associated with the cell is based at least in part on obtaining a list of a plurality of cell identifiers for a plurality of cells associated with a common operator for a geographical location, the cell is included in the plurality of cells.

Aspect 15: The method of any of aspects 1 through 14, wherein receiving the response further comprises: receiving, from the first network entity, a negative acknowledgement feedback message based at least in part on the indication of the operator identifier associated with the UE, wherein the negative acknowledgement feedback message indicates that the first network entity is not ready to transmit the system information block, the UE and the first network entity being associated with same operators.

Aspect 16: The method of any of aspects 1 through 15, wherein the operator identifier comprises an index indicating operator information, the index is included in a hash table.

Aspect 17: A UE for wireless communications, comprising one or more memories storing processor-executable code, and one or more processors coupled with the one or more memories and individually or collectively operable to execute the code to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a first network entity, a request for a system information block associated with a cell, wherein the request for the system information block comprises an indication of an operator identifier associated with the UE; and
receive, from the first network entity, a response to the request for the system information block based at least in part on the indication of the operator identifier associated with the UE.

2. The UE of claim 1, wherein, to receive the response, the one or more processors are individually or collectively further operable to execute the code to cause the UE to:
receive, from the first network entity, the system information block based at least in part on the indication of the operator identifier associated with the UE, wherein the UE and the first network entity are associated with a common operator.

3. The UE of claim 1, wherein, to receive the response, the one or more processors are individually or collectively further operable to execute the code to cause the UE to:
receive, from the first network entity, a negative acknowledgement feedback message based at least in part on the indication of the operator identifier associated with the UE, wherein the UE and the first network entity are associated with different operators.

4. The UE of claim 3, wherein the negative acknowledgement feedback message comprises an indication of a reason for denial of the request for the system information block.

5. The UE of claim 1, wherein, to transmit the request for the system information block, the one or more processors are individually or collectively further operable to execute the code to cause the UE to:
transmit a preamble signal requesting the system information block associated with the cell, wherein a sequence of the preamble signal indicates the operator identifier associated with the UE.

6. The UE of claim 1, wherein, to transmit the request for the system information block, the one or more processors are individually or collectively further operable to execute the code to cause the UE to:
transmit a message associated with a random access channel procedure, wherein the message comprises a payload indicating the operator identifier associated with the UE.

7. The UE of claim 6, wherein the operator identifier associated with the UE comprises a complete public land mobile network identifier, or a partial public land mobile network identifier.

8. The UE of claim 1, wherein the one or more processors are individually or collectively further operable to execute the code to cause the UE to:
receive a downlink signal comprising a preamble identifier associated with the operator identifier, wherein the downlink signal comprises at least one of system information associated with the cell or a second cell, a radio resource control signal, a non-access stratum message, a location-specific signal, or any combination thereof.

9. The UE of claim 8, wherein the location-specific signal is associated with a registration area of the UE or a radio access network based notification area or both.

10. The UE of claim 1, wherein a preamble identifier associated with the operator identifier is preconfigured or obtained by the UE from a server.

11. The UE of claim 1, wherein the one or more processors are individually or collectively further operable to execute the code to cause the UE to:
receive, from a second network entity, a downlink signal comprising a preamble identifier indicating the operator identifier associated with the UE.

12. The UE of claim 1, wherein the first network entity is associated with a plurality of operators including an operator associated with the operator identifier, and the system information block comprises information associated with the operator.

13. The UE of claim 1, wherein the one or more processors are individually or collectively further operable to execute the code to cause the UE to:
receive, from the first network entity and prior to transmitting the request for the system information block, a broadcast signal associated with the cell, wherein the broadcast signal comprises an indication of an operator identifier associated with the cell.

14. The UE of claim 13, wherein the one or more processors are individually or collectively further operable to execute the code to cause the UE to:
compare the operator identifier associated with the cell with the operator identifier associated with the UE, wherein transmitting the request for the system information block is based at least in part on the operator identifier associated with the cell and the operator identifier associated with the UE being same.

15. The UE of claim 1, wherein:
the request for the system information block associated with the cell is based at least in part on obtaining a list of a plurality of cell identifiers for a plurality of cells associated with a common operator for a geographical location,
the cell is included in the plurality of cells.

16. The UE of claim 1, wherein, to receive the response, the one or more processors are individually or collectively further operable to execute the code to cause the UE to:
receive, from the first network entity, a negative acknowledgement feedback message based at least in part on the indication of the operator identifier associated with the UE, wherein the negative acknowledgement feedback message indicates that the first network entity is not ready to transmit the system information block, the UE and the first network entity being associated with same operators.

17. The UE of claim 1, wherein the operator identifier comprises an index indicating operator information, and wherein the index is included in a hash table.

18. A method for wireless communications at a user equipment (UE), comprising:
transmitting, to a first network entity, a request for a system information block associated with a cell, wherein the request for the system information block comprises an indication of an operator identifier associated with the UE; and
receiving, from the first network entity, a response to the request for the system information block based at least in part on the indication of the operator identifier associated with the UE.

19. The method of claim 18, wherein receiving the response further comprises:
receiving, from the first network entity, the system information block based at least in part on the indication of the operator identifier associated with the UE, wherein the UE and the first network entity are associated with a common operator.

20. A non-transitory computer-readable medium storing code for wireless communications, the code comprising instructions executable by one or more processors to:
transmit, to a first network entity, a request for a system information block associated with a cell, wherein the request for the system information block comprises an indication of an operator identifier associated with a user equipment (UE); and
receive, from the first network entity, a response to the request for the system information block based at least in part on the indication of the operator identifier associated with the UE.
